(19) United States
(12) Patent Application Publication
(10) Pub. No.: US 2002/0025084 A1
(43) Pub. Date: Feb. 28, 2002

(54) Transfer and display method of digitally enlarged images

(76) Inventors: Yun-Won Yang, Seoul (KR); Dong-Hwal Lee, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/927,309

(22) Filed: Aug. 13, 2001

(30) Foreign Application Priority Data
Aug. 24, 2000 (KR) 2000-49183

(51) Int. Cl. G06K 9/32

(52) U.S. Cl. 382/299

(57) ABSTRACT

An enlarged digital image providing method and apparatus using data communication networks for effectively transmitting and displaying enlarged digital images via Internet, Intranet and mobile communication networks, wherein the method comprises the steps of: creating an original digital image document; serially creating at least one reduced image document having a resolution lower than the original digital image document based on the original digital image document; divisibly storing the reduced image documents and the original digital image document into a multiplicity of segmental image documents; receiving a request when a client designates a specific domain of a display image for enlarged display of the domain; and transmitting from server side to client side at least one segmental image document necessary for constructing an image of requested enlarged domain to prompt the transmitted segmental image document to be combined for implementation of displayed image.

### FIELD OF THE INVENTION

The present invention relates to a transfer and display method of digitally enlarged images adapted to effectively transfer and display digitally enlarged images through data communication networks such as Internet, Intranet and mobile communication network.

### DESCRIPTION OF THE PRIOR ART

Documents (Particularly, Hyper Text Markup Language (HTML) documents) provided from client side through communication networks such as Internet and the like are insertedly displayed with various shapes of image documents, where data of these image documents occupy relatively large date capacity in comparison with text data, which becomes an important element in determining time up to displaying whole associate documents following request of transfer of particular documents from client side.

Recently, through the assistance of high performance of server computer, development of data compression techniques, and physical performance improvement of transmission lines, demand by general Internet users on high speed has been realized relatively to a large extent.

However, according as the communication-related techniques are progressed, user demand levels are also increased such that user demands on receiving faster high quality of images is still going strong as ever, even though sophisticated communication techniques are being developed.

Meanwhile, a method is being widely used where a plurality of thumbnail individual image objects are firstly displayed on web page documents for providing a plurality of images as a means of compromising the user demands and limitation of techniques on Internet web pages, and then only against the request by the user for selected enlargement display out of the individual objects, an enlarged image data linked to the thumbnail image is transmitted to thereby display same on the user's screen. The method has an advantage of relatively reducing image data transmission amount in that unnecessary transmissions relative to image data not required by the user can be deleted.

Furthermore, there are many cases where, visitors to Internet web sites operated around inserted images such as online shopping malls, travels, tourist guide sites and the like, image analyzers of defense-associated photographs and medication-related photographs, designate a particular portion in relation to images inserted as part of document to request a detailed observation on a shooting object. These kinds of requests can be realized by addition of partial enlargement function relative to disclosed images. Several methods have been proposed for reduction of transmission data amount and for realization of enlargement observation request against a particular image of document viewer as well.

A prior art of using partial enlargement display method for a particular image was developed by Live Picture Inc. (www.mgisoft.com) of USA which was merged and acquisitioned later by MGI Software Corporation. Another prior art is Live Picture Image Server (referred to simply as an “image server”) which is sold world-wide.

The image server, a format of digital image file having a multiple resolution, and co-developed by Live Picture Inc., Eastman Kodak Company and Hewlett-Packard Company, has been developed on a base of industrially-disclosed FlashPix format (or IIP: Internet Imaging Protocol). When part of image being viewed at client side is selected and requested for enlargement, an enlarged image created to include a region requested by server side is provided to client side.

FIG. 1 schematically shows a pictorial image processing in the aforementioned image server for providing an enlarged image in response to client request based on FlashPix format.

As illustrated in FIG. 1, an image server 300 stores multiplicity of image files having tiled structure of resolutions relative to particular images, and when a client accesses to a web page for image provision, an image of the lowest resolution (level 1) thereamong is provided to the client as an initial display image (\mathring{1}). When an enlargement against a particular portion of image displayed by the client is requested, an image is extracted, the image including a designated portion from an image prepared in a higher resolution by one step (level 2) than the image requested by the client and currently displayed, whereby an image file to be transmitted based on the extracted image is constructed.

Furthermore, the image file thus constructed is transmitted to client side to allow the client to ascertain same (\mathring{2}) The processing can be repeatedly performed to an image of higher resolution (\mathring{3}). There is an advantage in the enlargement image providing method thus described in that interactive response can be possible according to client request whereby an enlarged image against portion of a current image can be transmitted and displayed.

However, there is a disadvantage in the prior art thus described in that, when a client requests an enlargement of a particular portion, there is no way of deleting a process of extracting a portion containing a portion designated by an image having a higher resolution by one step than a current image in a processing against the client request, and deleting a process of creating a new image file (JPEG file) only from the extracted portion.

Particularly, this type of process includes an image processing whereby a relatively large number of operating processes are required. As a result, a fatal disadvantage cannot be avoided where a consumed time is lengthened from a client request of an enlargement transmission up to response thereto. What is still worse is that delay in response is markedly increased as the number of accessors to image server are increased.

There is another disadvantage in the prior art thus described in that an image server of high price should be equipped in order to provide a relatively not-unsatisfactory response to a client request. In other words, in order to be able to serve stably by way of reducing response time even though plural clients are accessed, the most important thing is to shorten an operating process speed, and in order to supplement this object, it is essential to have a server of high speed and large capacity equipped. In this regard, it is a disadvantage to equip a server facility of high price for the stable service.

There is still another disadvantage in the prior art thus described in that images stored in a cache memory at client side cannot be utilized even if there are frequent requests of marked region movement against indicated image in response to panning control of client, such that the afore-mentioned complicated operation should be repeated by server side at every time. As a result, transmission data cannot be reduced in capacity thereof nor method of improving the response speed can be applied by means of utilizing cache memory and the like, thereby resulting in creation of bad user interface environment.

As a more specific example, a case can be thought of where a client intends to pan an enlargement indicated image. (most of the cases, when a viewer drags up, down, left or right, or when a panning control plate is pressed while an indicated image is clicked, an indicated region of indicated image is made to move in response thereto).

In this case, when a client drags around an indicated image to frequently perform a panning control for a detailed observation (when an indicated image is changed from region 111 to region 113 in FIG. 1), an indicated region of enlarged image requested by the client is also swiftly and continuously changed in response thereto such that an operated quantity at an image server is simultaneously increased (extraction of image data to be indicated, creation of image file indicated from the extracted file, operated quantity for transmission of created image file, by way of example, an operating process for extracting \mathring{4} of FIG. 1). However, as it is difficult to re-use the image previously received by cache memory at the client side, equipment of still higher price having a faster response speed should be mounted in order for the image server to support the client control without any strains thereto and to naturally indicate the image.

### SUMMARY OF THE INVENTION

It is a technical object of the present invention to provide an enlarged digital image providing method and an apparatus using data communication networks, wherein a complicated operation processing implemented at server side during image enlargement request from client side can be drastically reduced, and at the same time overall process speed and user environment can be improved by utilizing image document priorly received and stored in cache memory for prompt response when there are frequent requests from client side of indicated position movement control (panning control) against enlarged image, and stable service can be implemented even though a plurality of clients are accessed.

It is another technical object of the present invention to provide an enlarged digital image providing method and an apparatus using data communication networks wherein installation cost (equipment purchase cost) for constructing a server can be markedly reduced because no special load is required at server side for providing an enlarged image.

In accordance with an aspect of the present invention, there is provided an enlarged digital image providing method, the method for providing a digital image from a server to a client via digital networks and providing an enlarged digital image relative to a designated domain as a client is viewing a displayed image designates a specific domain of the displayed image for request of enlarged display, the method comprising the steps of: creating an original digital image document (Level=N) via shooting an object; serially creating at least one reduced image document (Level=N−1˜Level=1) having a resolution lower than the original digital image document based on the original digital image document; creatively dividing the serially created reduced image documents and the original digital image document into a multiplicity of segmental image documents; storing in a storage at server side each of the multiplicity of the segmentally divided created image documents, reduced level information for indicating reduced image level and position information (X, Y) for indicating positions of entire image document before division; providing as an initial display image a reduced image document (Level=1) of final level out of the reduced image documents in response to request by a client for image display; receiving a request when a client designates a specific domain of a display image (Level=r, 1≦r≦N−1) currently displayed on a display window as a requested enlarged domain and requests transmission of enlarged image (Level=r+1) for enlarged display of the domain; and transmitting from server side to client side at least one segmental image document (Level=r+1) necessary for constructing an image of requested enlarged domain in response to contents of received request to prompt the transmitted segmental image document to be combined for implementation of displayed image.

In accordance with another aspect of the present invention, there is provided an enlarged digital image providing apparatus using data communication networks, the apparatus for providing a digital image from a server to a client via digital networks and providing an enlarged digital image relative to a designated domain as a client viewing a displayed image designates a specific domain of the displayed image for request of enlarged display, the apparatus comprising: means for serially creating at least one reduced image document (Level=N−1˜Level=1) having a resolution lower than the original digital image document based on an original digital image document (Level=N) created via shooting an object; means for creatively dividing the serially created reduced image documents and the original digital image document into a multiplicity of segmental image documents; means for storing in a storage at server side each of the multiplicity of the segmentally divided created image documents, reduced level information for indicating reduced image level and position information (X, Y) for indicating positions of entire image document before division; communication means for communicating with client via data communication networks to receive client request and to respond thereto; image transmission control means for receiving a request when a client designates a specific domain of a display image (Level=r, 1≦r≦N−1) currently displayed on a display window as a requested enlarged domain and requests transmission of enlarged image (Level=r+1) for enlarged display of the domain to select a segmental image document (Level=r+1) necessary for constituting an image for requested enlarged domain and to allow the selected segmental image document to be provided to client side from the storage through the communication means, thereby combining the transmitted segmental image document to enable to constitute a display image.

In accordance with further another aspect of the present invention, there is an enlarged digital image providing method thus constructed, the enlarged digital image can be effectively provided even with deletion of complicated operation process implemented in the course of request of enlarged image from client side. As a result, server structure can be simplified, response speed of server can be improved, simultaneous accessability of clients can be enhanced, and structuring cost of digital image providing server and server incrementing cost can be reduced.

In accordance with the enlarged digital image providing method, the method comprising the steps of: receiving contents of a request when a client indicates a moved display domain to request a moved display for moving a domain currently displayed on a display window while an enlarged image (Level=r′, 2≦r≦n) is being viewed, and transmitting from server side to client side at least one segmental image document (Level=r′) necessary for structuring an image of designated moved display domain based on the received request of contents, allowing a priorly transmitted segmental image document to be combined with an additionally transmitted segmental image document to enable to implement an image of moved display domain.

In accordance with further another aspect of the present invention, there is provided an enlarged digital image providing apparatus using data communication networks, the apparatus including image transmitting control means, wherein the image transmitting control means receives contents of a request when a client indicates a moved display domain to request a moved display for moving a domain currently displayed on a display window while an enlarged image (Level=r′, 2≦r≦n) is being viewed, and transmitting from server side to client side at least one segmental image document (Level=r′) necessary for structuring an image of designated moved display domain based on the received request of contents, and enabling the selected segmental image document to be additionally provided from storage to client side via communication means, thereby to allow a priorly transmitted segmental image document to be combined with an additionally transmitted segmental image document for constitution of an image of moved display domain.

In accordance with the enlarged digital image providing apparatus thus constructed, no additional operating process is required at server side to thereby enable to respond more swiftly even though there are frequent control requests from client of moving the display domain. Moreover, in the present invention, an entire display screen is mosaically combined using a multiplicity of segmental image documents, allowing to utilize segmental image documents stored in a cache memory of client such that quantity of data transmission through networks can be drastically reduced and response speed to client request can be enhanced, thereby improving user's environment remarkably.

Furthermore, in accordance with the enlarged digital image providing method and apparatus using data communication networks of the present invention thus described, it is preferable that the segmental image documents created by dividing the serially reduced and created image documents are implemented each in the same size at all levels.

In other words, although the segmental images may not be structured each in the same size, same size of structure would make it easy to control the data at server side and simultaneously enable to perform a faster process.

Still furthermore, in accordance with a preferred embodiment of the present invention, the original digital image document and reduced image document (Level=1˜N) may be provided as one group of image document style to be sequentially and alternatively displayed when a client views same.

Likewise, when technique of providing three-dimensional image by using three-dimensional image effect, which is generated when consecutively-shot multiplicity of individual image are serially and alternatively displayed, is incorporated by the enlarged digital image providing technique, three-dimensional display image can be effectively enlarged and displayed by designating a specific position of particular frame, and particularly, even when a client requests frequent changes of display status, a good quality of three-dimensional display image can be viewed at a high response speed.

Furthermore, in accordance with another embodiment of the present invention, the original digital image document and reduced image document (Level=1˜N) can be created by dividing the multiplicity of image documents obtained by panoramic photographing by segmental image documents and then combining same mosaically.

As described above, a camera is rotated in a particular space for panoramic photographing to obtain a plurality of image documents, and the respective image documents are divided by a multiplicity of segmental image documents and combined mosaically to obtain a combined image relative to entire space by way of incorporation of consecutive images, where the present invention is incorporated with panoramic cubic space image technique utilizing a three-dimensional space effect generated in the course of consecutively displaying the combined images whereby a specific portion can be effectively enlarged and displayed even against panoramic three-dimensional images.

Moreover, even though a client requests frequent changes of display status, the three-dimensional display spatial images can be viewed at a high response speed.

### BRIEF DESCRIPTION OF THE DRAWINGS

Other objects and aspects of the invention will become apparent from the following description of the embodiments with reference to the accompanying drawings, in which:

FIG. 1 is a schematic pictorial for illustrating an image processing concept of an image server for using FlashPix Format ® {a registered trademark of the Digital Imaging Group (DIG)} according to the prior art;

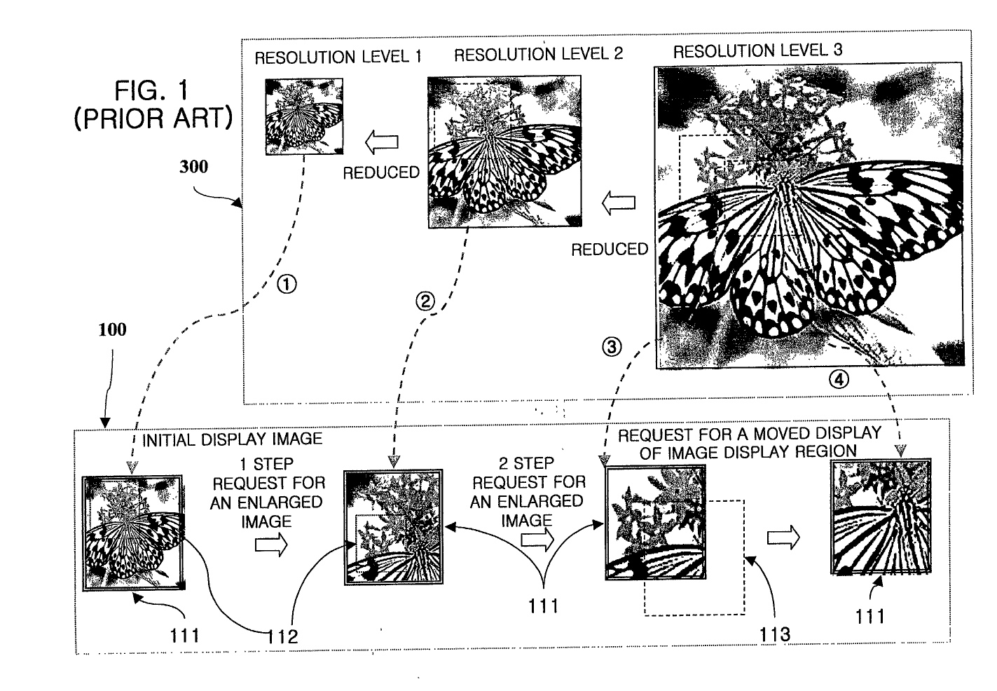

FIG. 2 is a schematic pictorial for illustrating an image processing concept used in an enlarged digital image providing method according to the present invention;

FIG. 3 is a schematic diagram for illustrating structure of enlarged digital image providing apparatus according to the present invention;

FIG. 4 is a flow chart for illustrating a creation process of reduced digital image and segmental image with an original digital image on hand in an enlarged digital image providing apparatus according to the prior art;

FIG. 5 is a flow chart for illustrating a process where a client accesses to an enlarged digital image providing apparatus according to the present invention to view an image, and a processing thereof;

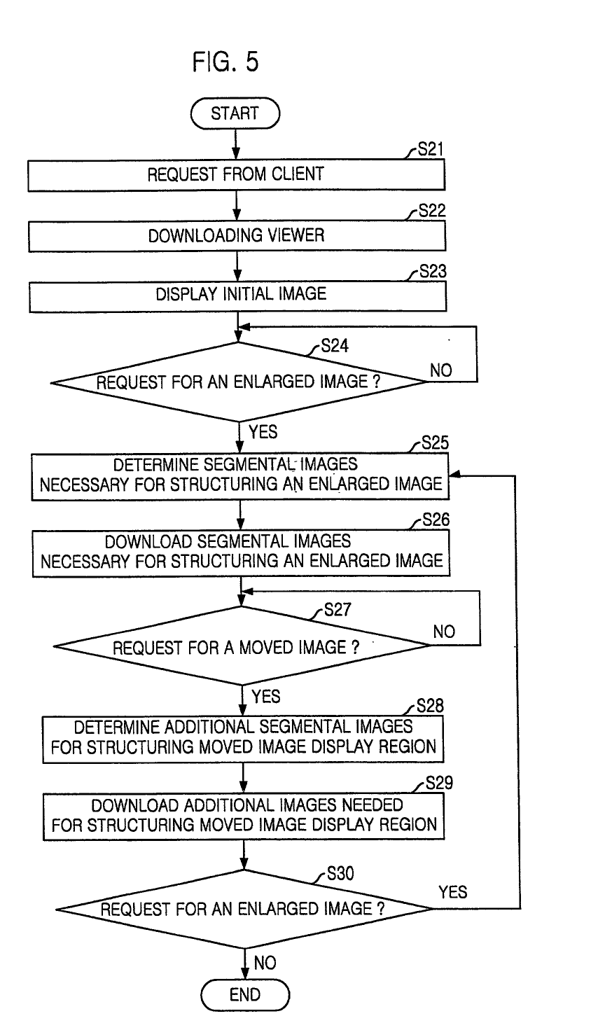

FIGS. 6A to 6D illustrate states of capture screens where two-dimensional display images are enlarged step by step and viewed in an embodiment constructed on an enlarged digital image providing method according to the present invention;

FIGS. 7A to 7C illustrate states of capture screens where display images are panned and viewed in FIG. 6D;

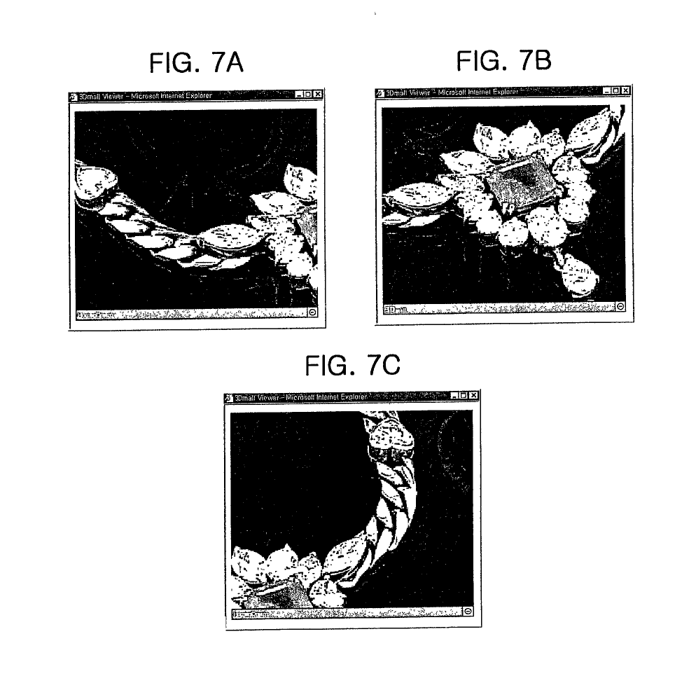

FIGS. 8A to 8D illustrate states of capture screens where three-dimensional display images (three-dimensional object images) are rotated and viewed in an embodiment structured on an enlarged digital image providing method according to the present invention;

FIGS. 9A to 9C illustrate states of capture screens where enlarged images received step by step in response to request of enlarged images by client who designates a specific region in FIG. 8D are observed while FIG. 9D illustrates a state of capture screen where FIG. 9C is panned and observed;

FIGS. 10A to 10D illustrate states of capture screens where three-dimensional space images (three-dimensional panoramic images) are rotated and observed in an embodiment structured on an enlarged digital image providing method according to the present invention; and

FIGS. 11A to 11D illustrate states of capture screens where a screen obtained from one of the screens in FIGS. 10A to 10D for enlarged image display is panned up, down, left and right, and viewed.

### DETAILED DESCRIPTION OF THE INVENTION

Now, preferred embodiments of the present invention will be described in detail with reference to the accompanying drawings.

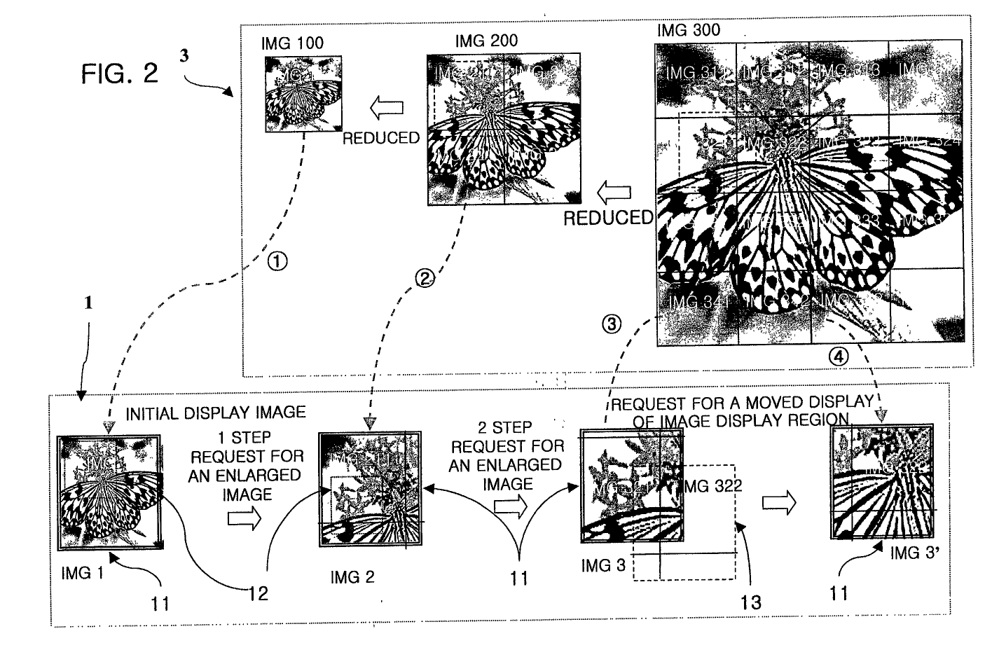

FIG. 2 is a schematic concept drawing for illustrating a principle of how an enlarged image transmission method structured according to the present invention is implemented.

As illustrated in FIG. 2, a server 3 for providing an enlarged image according to the present invention reduces the number of image pixels based on an original image (Img 300 in FIG. 2) and creates reduced images (Img 200, Img 100) step by step, where the reduced images are stored in multiplicity with the original image.

Each stored reduced image document per step (Img 100, Img 200, Img 300) is not an image document but is implemented in a style of forming an entire image by combining a plurality of segmental image documents (by way of example, Img 211, Img 212, Img 221 and Img 222 are combined to form Img 2). This style of construction is applied in the same fashion to an original image (by way of example, Img 300) and other steps of reduced images except for an image document (Img 100) which is made in low resolution and provided as an initial display image viewed by a client.

When relation between all segmental images and each image is established in this style, a client 1 can view images by accessing to the server 3 through Internet, Intranet, radio Internet or the like.

At this time, the client 1 can review in the first place an initial display image (Img 111=Img 100=Img 1) via a provided display window 11(\mathring{1}).

Furthermore, in case the client wants a detailed observation on a specific portion while reviewing the initial display image, the client can select a region desired for enlargement and request an enlarged image for corresponding portion.

An enlarged image viewing process by a client will be described with reference to contents in FIG. 2.

When a client designates a specific region (blurringly indicated portion) as an enlarged region to request an enlarged display image while viewing a first screen at lower left of FIG. 2 as an initial screen, the server 3 sequentially transmits to a client segmental images (Img 211, Img 212, Img 221, Img 222) necessary for displaying a designated region out of segmental images constituting an image (Img 200) higher in resolution by one level than the image currently displayed, thereby providing an enlarged image (Img 2) against the designated portion as illustrated in second left lower screen of FIG. 2 (\mathring{2}).

Furthermore, when the client again designates a particular region in the displayed image (Img 2) to request an enlarged image against corresponding region, the server 3 sequentially transmits to the client segmental images (Img 311, Img 312, Img 321, Img 322) necessary for displaying a designated region out of segmental images forming an image (Img 300) higher in resolution by one level than the currently displayed image (Img 2), to thereby provide an enlarged image (Img 3) relative to the designated portion as illustrated in third left lower screen of FIG. 2 (\mathring{3}).

Although the enlargement procedure depends on how many steps image levels are constituted, the procedure is repeated until a final image (Img N) of an optimum resolution is displayed.

Meanwhile, when a client desires a currently displayed region to be moved while observing a displayed image, the client can drag a related screen by mouse, or click a panning control button at a control panel (which is separately provided) to implement the movement request relative to the displayed region.

By way of example, when a display region indicating a third display image (Img 3) from a lower left side of FIG. 2 is indicatively moved to allow a client to observe a display image (Img 3′), segmental images (Img 321, Img 322, Img 331 and Img 332) necessary for forming \mathring{4} the moved display region (Img 3′) are calculated, and images (Img 331, Img 332) out of segmental images not previously placed by the client are newly requested for transmission.

At this time, the images (Img 321, Img 322) are the ones previously received and stored in cache memory when the enlarged image (Img 3) is to be viewed, such that there is no need to transmit same newly as long as they are not erased from the cache memory.

As described above, segmental images necessary for constituting an enlarged image at server side are prepared beforehand and only one segmental image thereamong requested by a client as necessity for display on a screen is immediately transmitted whereby complicated operation processes such as image extraction, creation and the like are almost deleted for display of an enlarged image.

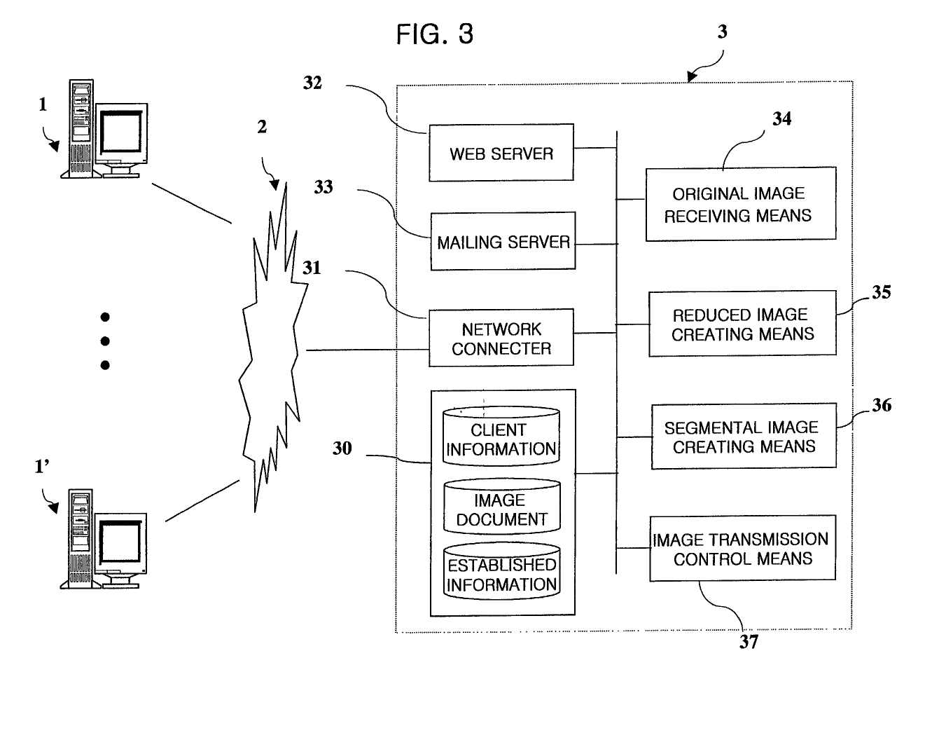

FIG. 3 is a schematic block diagram for illustrating construction of an enlarged digital image providing apparatus for implementing an enlarged digital image providing method according to the above-mentioned concept.

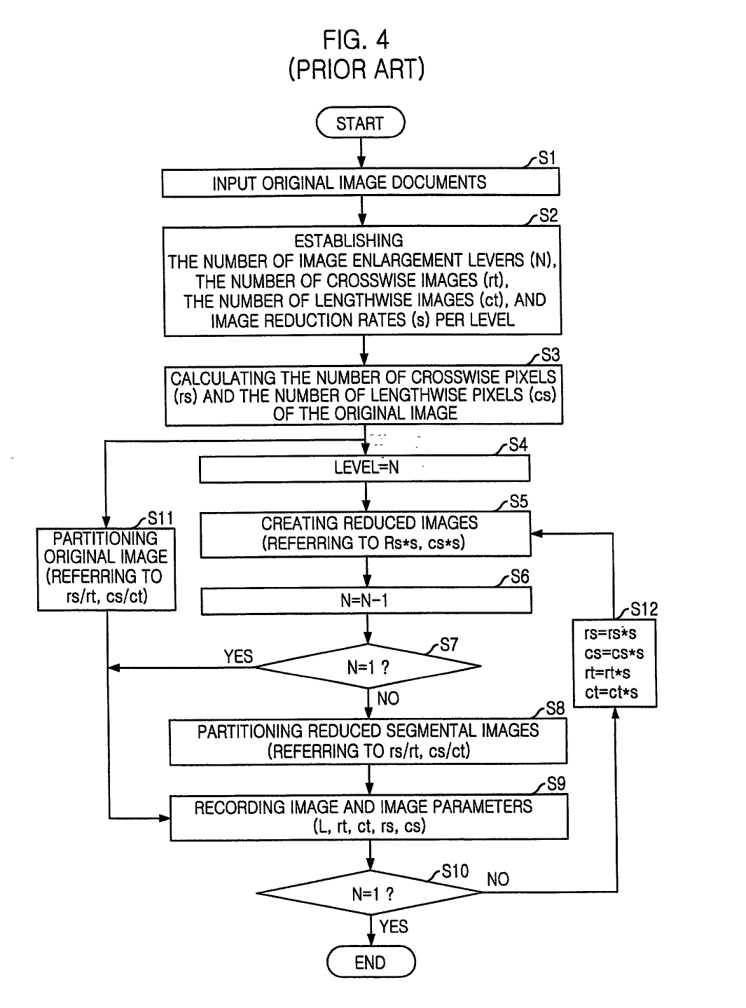

Now, operational process of the present invention will be described in detail with reference to sequential control in the enlarged digital image providing apparatus illustrated in FIGS. 3 and 4.

An enlarged digital image providing apparatus 3 of FIG. 3 according to the present invention basically includes a network access processor 31 for being accessed to communication networks such as Internet and the like to process data by way of sending and receiving, a web server 32 for providing images to clients via web pages, and a mailing server 33 for providing images to clients through electronic mails, electronic catalogues.

Method and citation for providing documents including two-dimensional images, three-dimensional images and three-dimensional spatial images using web server and mailing server may be accessed a web site (www.humandream.com) served by the present applicant or may be ascertained by visiting to the web site mentioned in the description of the prior art.

Particularly, detailed description about a method for inserting three-dimensional images to electronic catalogues for transmission may be ascertained from Korean Patent Application No. 10-2000-0047119 filed by the present applicant.

An enlarged digital image providing apparatus 3 of the present invention further includes an original image receiving means 34, reduced image creating means 35, segmental image creating means 36, image transmission control means 37, while a record storage 30 stores segmental image documents and original image documents created by processes described with reference to FIG. 2.

Original image receiving means 34 needs to be equipped with control means (driver) for communicating with outside apparatus such as digital cameras (not shown) and scanners (not shown) and receiving data therefrom in order to receive in the form of digital data. Besides, by accessing to Internet, Intranet and radio communication network via the network access processor 31, data may be also obtained by other computers accessed to network, step S1.

When the original image documents are received and data thereof is stored in the record storage 30, the reduced image creating means 35 creates reduced image documents based on previously established parameters.

Establishment for parameters such as the number of image enlargement levers (N), the number of entire segmental images (the number of crosswise images (rt) X the number of lengthwise images (ct), image reduction rates (s) per level are implemented beforehand by administrator and result thereof is stored in an administrator region of the record storage 30 (step S2).

When the original image document is input after completion of the establishment, the number of crosswise pixels (rs) and the number of lengthwise pixels (cs) of the original image are calculated (step S3). When the reduction rate (s) is established by the administrator and the numbers of crosswise and lengthwise pixels (rs, cs) are calculated, the original image is established as N step (step S4) while reduced images to be created step by step thereafter are sequentially established as N-1 step, N-2 step . . . , 2 step, whereby reduced images (by way of example, Img 200, Img 100), each number of pixels thereof being smaller than that of the original image, are sequentially created from the original image (Img 300), (step S5). This process is continued until a final reduced image (Img 100) is generated, step S10. At this time, the numbers of pixels possessed by the reduced image to be created are respectively rs*s and cs*s at crosswise direction and lengthwise direction.

Segmental image creating means 35 partitions the reduced images created by the reduced image creating means 35 and original image into a plurality of segmental images respectively having the number of crosswise pixels and lengthwise pixels-at rs/rt and cs/ct, step S8 and step S11.

Furthermore, the segmental images partitioned into a plurality of same-sized images are each created as independent image document and stored in the storage 30 along with parameters of corresponding images, step S9.

The process, where reduced images are created in stages by the reduced image creating mans 34 and reduced images created by the segmental image creating means 35 are divided into the multiple images, each of same size, and stored in the record storage 30 along with the parameters as independent segmental image documents, is repeated until a final reduced document (Img 100) of final stage is created and stored (N=1 at step S7), steps S10 and S12.

When the original image and reduced images are prepared by the above-mentioned method, and the original image and reduced images are respectively generated into segmental image documents and stored in the storage, all the preparations for client are finished for the time being.

The image transmission control means 37 serves to implement a control for transmission to client side of segmental image documents necessary for enlarged image display or moved image display in response to client's request when the client views image documents provided by web server 32 or mailing server 33 to designate part of corresponding image documents in point to request an enlarged image thereof or to request a moved display of image display region.

The image transmission control means 37 may be integrated with partial function of web server 32.

FIG. 4 illustrates an order of processing response at viewer side when a client uses his or her terminal to access to server side for viewing of image document, and designates a specific region of the image document for the purpose of a detailed observation and requests an enlarged image or a moved image display.

When a client views an image document from which an enlarged image service is provided according to the present invention, step S21, a viewer for implementing process at client side for enlarged image is downloaded along with an initial image, step S22.

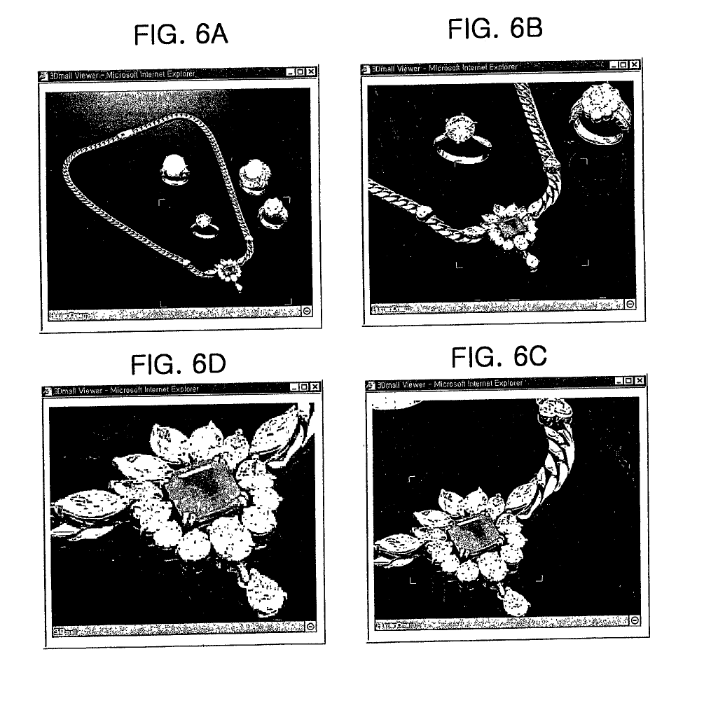

The viewer program is generally structured in Java applet and the client may ascertain the initial image supplied through such windows as illustrated in FIGS. 6A, 8A and 10A, step S23.

The client can directly click by mouse a control icon on control panel or an image provided with the display window to thereby perform a control necessary for enlarged image display request, moved image display request and the like.

By way of example, when a client presses an icon “+” on control panel illustrated in FIG. 6A, a rough sketch is displayed against a region to be displayed after enlargement about the position of mouse cursor, and the mouse is moved to designate a region necessary for enlargement, whereby an image enlargement for a server is requested, step S24.

When there is an image enlargement request from a viewing client, a viewer discriminates what segmental image document is needed for enlarging a region designated and requested by a client as an enlarged region out of segmental image documents (by way of example, Img 200) prepared in a resolution level higher than that of the currently displayed image (Img 100), step S25, and a segmental image necessary for structuring an enlarged image at the enlarged region is downloaded from the server side, step S26.

At this time, the viewer refers to an image parameter transmitted with the display image to discriminate a segmental image necessary for constructing an image requested on the enlarged domain.

FIG. 6 illustrates a screen which has captured a state where the above-mentioned processes are repeated while display images are sequentially enlarged and viewed.

On this screen, the requested enlargement domain is displayed in a contour line about the mouse cursor but this shape on the domain may be round, triangular, rectangular or square as shape of the display window is changed.

When an image outside of the currently-displayed domain is to be viewed while a client is viewing an enlarged image, the client may pick up the image by way of mouse cursor, pan to the left or right, and move the display image for viewing, step S27.

At this time, a viewer discriminates what is needed for a segmental image necessary for constructing the moved display domain, where a corresponding segmental image is additionally downloaded for display on the display window.

Although images necessary for constructing a third lower left screen in FIG. 2 are Img 311, Img 312, Img 321, Img 322, the images become Img 321, Img 322, Img 331, Img 332 for displaying a newly requested domain 13 when a client pans the images to newly designate the moved display region 13.

The viewer uses the parameters to project the moved display domain on an enlarged image window for discrimination of necessary segmental image, step S28, where the segmental images Img 331, Img 332 are downloaded as additional images needed for moved image display to construct the moved display region 13, step S29.

Meanwhile, when the client moves to a screen a step before, the segmental images Img 311, Img 312 are again downloaded to construct a moved screen. However, in this case, the segmental images have been already downloaded during the view a little while ago such that images stored in the cache memory are used to construct the moved request screen 13.

Furthermore, when the client designates a specific region on the current display screen for request of a more detailed enlarged display, a segmental image is discriminated necessary for constructing a requested enlarged domain out of image documents having resolution of next steps, where a corresponding segmental image is downloaded from a server to construct a display screen. Subsequent processes are the same processings when an image document having a resolution of previous stage is enlarged for display (step S30→step S25).

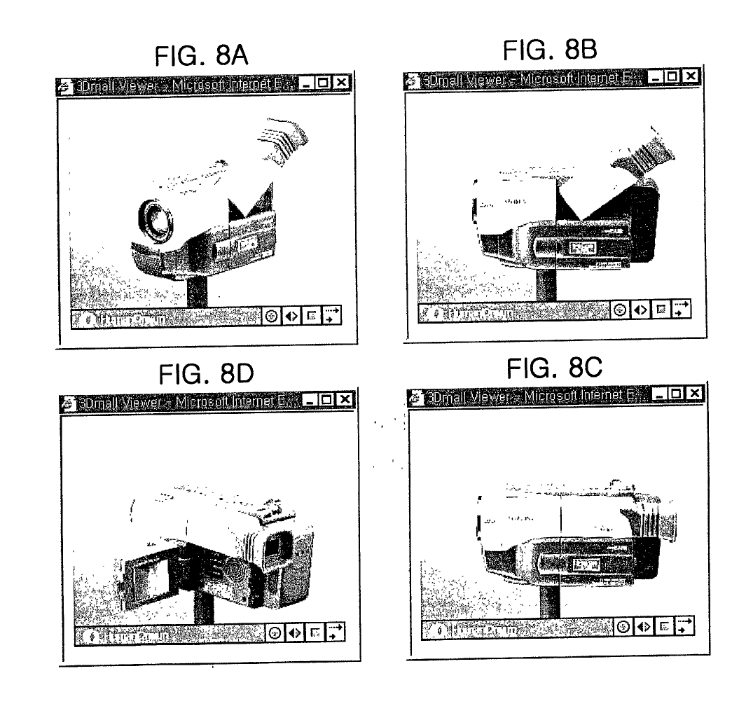

FIGS. 8A to 8D illustrate state of capture screens where a client turns to view an initial display screen constructed in three dimensional display image (three dimensional object image) in an embodiment structured on an enlarged digital image providing method according to the present invention.

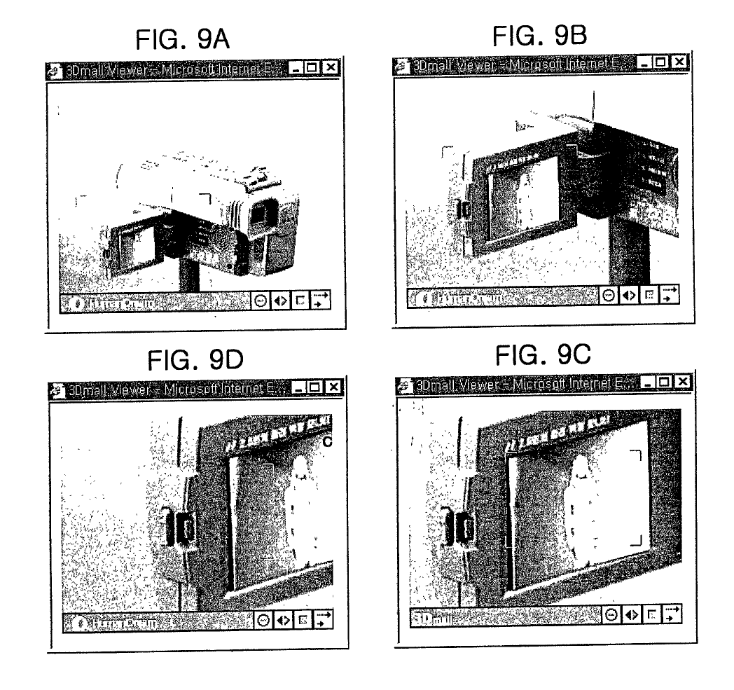

Even in this case, as illustrated in FIGS. 9A to 9C, enlarged image documents may be received by stages to enable to view enlarged three dimensional images as a client designates a part of display screen to request an enlarged image. Furthermore, as illustrated in FIG. 9D, a display domain can be moved. In order to provide effects thus described, enlarged images should be prepared in the same shape as illustrated in FIG. 2 relative to respective images shown in FIGS. 8A to 8D.

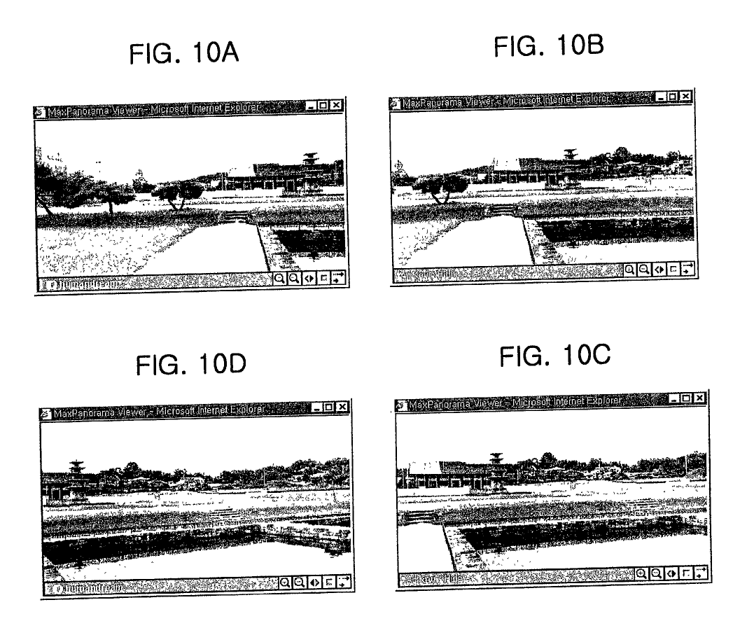

FIGS. 10A to 10D illustrate states of capture screens where a client turns to view an initial display screen structured in three dimensional spatial image (three dimensional panoramic image) in an embodiment structured on an enlarged digital image providing method according to the present invention.

On the display screen, the client can view the panoramic cubic screens shown in FIG. 10 by way of selecting an icon on the control panel or directly panning an image.

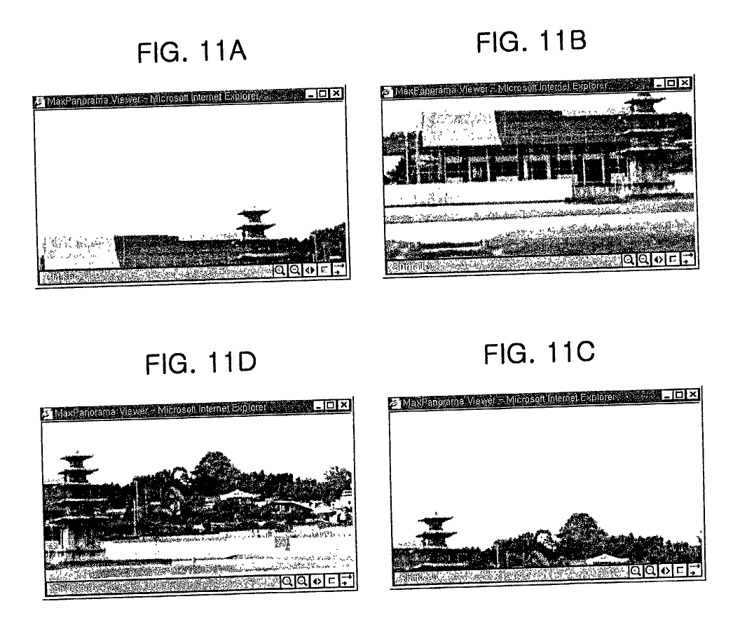

Furthermore, FIGS. 11A to 11D illustrate states of capture screens where screens are panned up, down left and right for viewing while an enlarged image is requested and obtained from one of the screens in FIGS. 10A to 11D.

In order to provide an effect of enlarged image relative to the three dimensional panoramic images thus described, it should be apparent that enlarged images be prepared as illustrated in FIG. 2 relative to each segmental image made out for structuring image documents illustrated in FIG. 10.

As described above, the present invention has described about an enlarged digital image providing method and apparatus using data communication networks. However it should be understood that the present invention is not to be limited to the specific embodiments, but various changes and modifications can be added by one skilled in the art without departing from the scope of the present invention as defined in the appended claims.

As apparent from the foregoing, there is an advantage in the enlarged digital image providing method and apparatus using data communication networks thus described according to the present invention in that enlarged images can be provided through data communication networks, such that, when there is a request from client side for enlarged images or moved image displays, complicated operating processes implemented at server side can be greatly reduced, thereby enabling to produce server at an inexpensive cost.

There is another advantage in that, when there is a request from client side for enlarged images or display of moved position of images, complicated operating processes at server side can be deleted, thereby enabling to respond promptly to the client's request.

There is still another advantage in that, even if a plurality of clients are simultaneously accessed, server can be structured at an inexpensive cost for implementing stable services.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An enlarged digital image providing method using data communication networks, the method for providing a digital image from a server to a client via digital networks and providing an enlarged digital image relative to a designated domain as a client viewing a displayed image designates a specific domain of the displayed image for request of enlarged display, the method comprising the steps of:
creating an original digital image document (Level=N) via shooting an object;
serially creating at least one reduced image document (Level=N−1˜Level 1) having a resolution lower than the original digital-image document based on the original digital image document;
creatively dividing the serially created reduced image documents and the original digital image document into a multiplicity of segmental image documents;
storing in a storage at server side each of the multiplicity of the segmentally divided created image documents, reduced level information for indicating reduced image level and position information (X, Y) for indicating positions of entire image document before division;
providing as an initial display image a reduced image document (Level=1) of final level out of the reduced image documents in response to request by a client for image display;
receiving a request when a client designates a specific domain of a display image (Level=r, 1≦r>N−1) currently displayed on a display window as a requested enlarged domain and requests transmission of enlarged image (Level=r+1) for enlarged display of the domain; and
transmitting from server side to client side at least one segmental image document (Level=r+1) necessary for constructing an image of requested enlarged domain in response to contents of received request to prompt the transmitted segmental image document to be combined for implementation of displayed image.

2. The method as defined in claim 1, further comprising the steps of:
receiving contents of a request when a client indicates a moved display domain to request a moved display for moving a domain currently displayed on a display window while an enlarged image (Level=r′, 2≦r≦n) is being viewed, and
transmitting from server side to client side at least one segmental image document (Level=r′) necessary for structuring an image of designated moved display domain based on the received request of contents, and enabling the selected segmental image document to be additionally provided from storage to client side via communication means, thereby to allow a priorly transmitted segmental image document to be combined with an additionally transmitted segmental image document for constitution of an image of moved display domain.

3. The method as defined in claim 1, wherein segmental image documents created by dividing the sequentially reducibly created image documents are respectively of the same size at all levels.

4. The method as defined in claim 2, wherein segmental image documents created by dividing the sequentially reducibly created image documents are respectively of the same size at all levels.

5. The method as defined in claim 1, wherein the original digital image documents and reduced image documents (Level=1˜N) are provided as one group of image document style to be sequentially and alternatively displayed when a client views same.

6. The method as defined in claim 2, wherein the original digital image documents and reduced image documents (Level=1˜N) are provided as one group of image document style to be sequentially and alternatively displayed when a client views same.

7. The method as defined in claim 1, wherein the original digital image documents and reduced image documents (Level=1˜N) are created by dividing the multiplicity of image documents obtained by panoramic photographing according to segmental image documents and then combining same mosaically.

8. The method as defined in claim 2, wherein the original digital image documents and reduced image documents (Level=1˜N) are created by dividing the multiplicity of image documents obtained by panoramic photographing according to segmental image documents and then combining same mosaically.

9. An enlarged digital image providing apparatus using data communication networks, the apparatus for providing a digital image from a server to a client via digital networks and providing an enlarged digital image relative to a designated domain as a client viewing a displayed image designates a specific domain of the displayed image for request of enlarged display, the apparatus comprising:
means for serially creating at least one reduced image document (Level=N−1˜Level=1) having a resolution lower than the original digital image document based on an original digital image document (Level=N) created via shooting an object;
means for creatively dividing the serially created reduced image documents and the original digital image document into a multiplicity of segmental image documents;
means for storing in a storage at server side each of the multiplicity of the segmentally divided created image documents, reduced level information for indicating reduced image level and position information (X, Y) for indicating positions of entire image document before division;
communication means for communicating with client via data communication networks to receive client request and to respond thereto; and
image transmission control means for receiving a request when a client designates a specific domain of a display image (Level=r, 1≦r≦N−1) currently displayed on a display window as a requested enlarged domain and requests transmission of enlarged image (Level=r+1) for enlarged display of the domain to select a segmental image document (Level=r+1) necessary for constituting an image for requested enlarged domain and to allow the selected segmental image document to be provided to client side from the storage through the communication means, thereby combining the transmitted segmental image document to enable to constitute a display image.

10. The apparatus as defined in claim 9, wherein the image transmitting control means receives contents of a request when a client indicates a moved display domain to request a moved display for moving a domain currently displayed on a display window while an enlarged image (Level=r′, 2≦r≦n) is being viewed, and selecting at least one segmental image document (Level=r′) necessary for structuring an image of designated moved display domain based on the received request of contents, and enabling the selected segmental image document to be additionally provided from storage to client side via communication means, thereby to allow a priorly transmitted segmental image document to be combined with an additionally transmitted segmental image document for constitution of an image of moved display domain.

11. The apparatus as defined in claim 9, wherein segmental image documents created by dividing the sequentially reducibly created image documents are respectively of the same size at all levels.

12. The apparatus as defined in claim 10, wherein segmental image documents created by dividing the sequentially reducibly created image documents are respectively of the same size at all levels.

13. The apparatus as defined in claim 9, wherein the original digital image documents and reduced image documents (Level=1˜N) are provided as one group of image document style to be sequentially and alternatively displayed when a client views same.

14. The apparatus as defined in claim 10, wherein the original digital image documents and reduced image documents (Level=1˜N) are provided as one group of image document style to be sequentially and alternatively displayed when a client views same.

15. The apparatus as defined in claim 9, wherein the original digital image documents and reduced image documents (Level=1˜N) are created by dividing the multiplicity of image documents obtained by panoramic photographing according to segmental image documents and then combining same mosaically.

16. The apparatus as defined in claim 10, wherein the original digital image documents and reduced image documents (Level=1˜N) are created by dividing the multiplicity of image documents obtained by panoramic photographing according to segmental image documents and then combining same mosaically.
